(19) United States
(12) Patent Application Publication
(10) Pub. No.: US 2026/0063166 A1
(43) Pub. Date: Mar. 5, 2026

(54) CONNECTING ROD FOR AN INTERNAL COMBUSTION ENGINE

(71) Applicant: Cummins Inc., Columbus, IN (US)

(72) Inventors: Nikhil Vinayak Rao, Pune (IN); Sayali Apte, Mumbai (IN); Vikram Kumar, Bihar (IN); Anil Ashok Tiwari, Pune (IN)

(21) Appl. No.: 19/309,950

(22) Filed: Aug. 26, 2025

(30) Foreign Application Priority Data
Aug. 30, 2024 (IN) 202441065537

(51) Int. Cl. F16C 7/02

(52) U.S. Cl. CPC F16C 7/023

(57) ABSTRACT

A connecting rod including a connecting rod body having a piston end, an opposing crank end, and a shank extending between the piston and the crank ends. The connecting rod body has a longitudinal plane LP that extends between respective centers of the piston and the crank ends. The longitudinal plane LP extends between a center axis at the piston end and a center axis at the crank end of the connecting rod. The shank has an I-beam cross-sectional shape and stiffness that are asymmetrical relative to the longitudinal plane LP. The shank includes a first column portion having an offset side surface, a second column portion having an anti-offset side surface, and a web positioned closer to the anti-offset side surface. The anti-offset side surface and the offset side surface are each substantially parallel to the longitudinal plane.

### CROSS-REFERENCE TO RELATED APPLICATION

The present application claims the benefit of the filing date of Indian Provisional Application No. 202441065537 filed on Aug. 30, 2024, which is incorporated herein by reference.

### TECHNICAL FIELD

The present application relates generally to a connecting rod having a cross-sectional shape that is asymmetrical relative to a longitudinal plane for an internal combustion engine.

### BACKGROUND

Some engines include an offset crankshaft to improve performance and reduce noises. An offset crankshaft occurs when a longitudinal axis of the cylinder in which the piston reciprocates does not coincide with a crankshaft axis of rotation. For example, the crankshaft may be centered to the left or right of the cylinder axis. As the crankshaft rotates and a connecting arm swings inside a cavity of an engine block there is a small clearance on the side of the cavity that the crankshaft axis is offset towards. Additionally, since the connecting arm is offset then during operation of the connecting arm high bending loads or stress in the connecting arm can occur.

In the case of an engine with an offset crankshaft, a notch is often provided in the engine block to maintain clearance between the engine block and the connecting rod. The notch is located towards the side nearest the offset crankshaft axis. This clearance accommodates the manufacturing part to part variations, assembly variations, and dynamic clearance between the engine block and the connecting rod. The notch often includes sharp edges which can lead to bore scuffing and increased oil consumption in the engine.

Therefore, further contributions in this area of technology are needed to improve the durability of the connecting arm and maintain bore clearance.

### SUMMARY

A connecting rod for an internal combustion engine including a connecting rod body having a piston end, an opposing crank end, and a shank extending between the piston and the crank ends. The connecting rod body has a longitudinal plane that extends between respective centers of the piston and the crank ends. The shank has an I-beam cross-sectional shape that is asymmetrical relative to the longitudinal plane. The shank includes a web portion positioned between a first column portion and a second column portion wherein all of these sections extend between the piston end and the opposing crank end.

The first column portion includes an offset side surface relative to the longitudinal plane. The second column portion includes an anti-offset side surface relative to the longitudinal plane. The web portion is positioned closer to the anti-offset side surface. As such, the first column portion is positioned closer to the offset side surface whereas the second column portion and web are positioned closer to the anti-offset side surface. The anti-offset side surface and the offset side surface are each substantially parallel to the longitudinal plane.

A stiffness of a cross-sectional area of the first column portion is different than a combined stiffness of a cross-sectional area of the second column portion and a cross-sectional area of the web. Therefore, the shank has an asymmetric stiffness relative to the longitudinal plane wherein the higher stiffness is positioned closer to the off-set side to withstand higher stresses and bending forces that are caused by an offset crankshaft in the internal combustion engine. As such, the stiffness of the first column portion is higher than the combined stiffness of the cross-sectional area of the second column portion and the cross-sectional area of the web.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a front view of a connecting rod assembled with an illustrative embodiment of an internal combustion engine;

FIG. 2 is front view of the connecting rod of FIG. 1; and

FIG. 3 is a cross-sectional view taken along line 3-3 of the connecting rod of FIG. 2.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

A connecting rod is operably assembled with an offset crankshaft and a piston. In one embodiment, the notch in the engine block is removed from the engine block and the cylinder is raised in the engine block to accommodate the offset crankshaft. A connecting rod having an asymmetric cross section can provide adequate clearance with the bore and the engine block having the offset crankshaft. This configuration however results in a face of the shank of the connecting rod closest to the direction of the applied load from the crankshaft to receive a higher amount of stress and bending force. It is desirable to reduce the stress on and bending of the shank. The connecting rod described herein is configured to distribute the stiffness of the connecting rod to reduce the stress and bending of the shank while also maintaining adequate clearance with the bore and the engine block having an offset crankshaft.

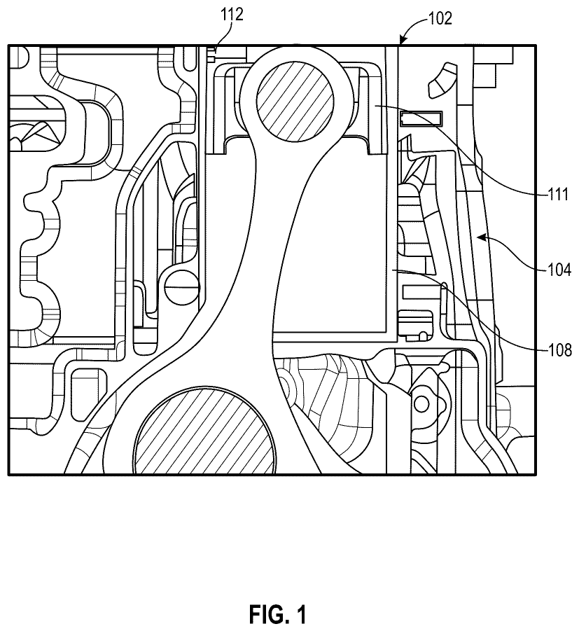

FIG. 1 illustrates an engine 102. Engine 102 is depicted in FIG. 1 and described herein as a diesel-fueled, internal combustion engine. However, it is contemplated that engine 102 may embody any other type of internal combustion engine such as, for example, a gasoline or gaseous fuel powered engine or a hydrogen internal combustion engine. It is contemplated that engine 102 may include any number of combustion chambers and that the combustion chambers may be disposed in an “in-line” configuration, in a “V” configuration, or in any other conventional configuration.

Engine 102 includes an engine block 104 at least partially defining a cylinder 108, and a cylinder liner may optionally be disposed in cylinder 108. A piston 111 may be located to reciprocate within the cylinder 108 or the cylinder liner, if present. Piston 111, together with cylinder liner (if present) and a cylinder head (not shown), may form a combustion chamber 112. Engine block 104 may also include a combustion air inlet, an air scavenging channel, and an exhaust outlet (not shown) in communication with combustion chamber 112.

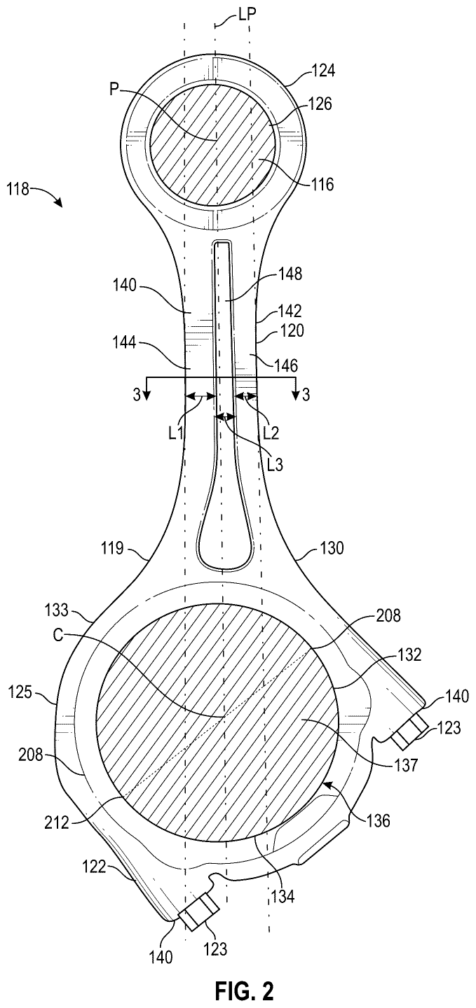

Additionally, a piston pin 116 may connect piston 111 to a connecting rod 118 as illustrated in FIG. 2. A crankshaft pivot pin 137 may connect a crankshaft (not shown) to the connecting rod 118 as illustrated in FIG. 2.

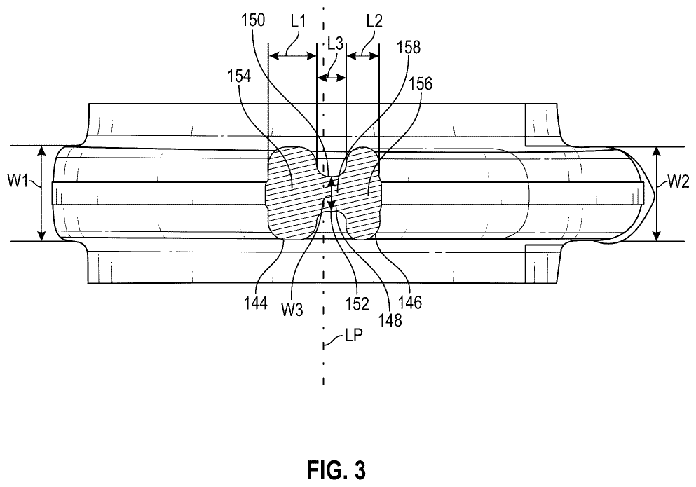

FIG. 2 illustrates the connecting rod 118 that includes a connecting rod body 119 having a piston end 124, an opposing crank end 125, and a shank 120 extending between the piston and the crank ends 124 and 125, respectively. The connecting rod body 119 has a longitudinal plane LP that extends between respective centers of the piston and the crank ends 124 and 125, respectively. The longitudinal plane LP extends between a center axis P at the piston end 124 and a center axis C at the crank end 125 of the connecting rod 118. The shank 120 has an I-beam cross-sectional shape that is asymmetrical relative to the longitudinal plane LP as illustrated in FIG. 3 and described below. The shank 120 has an asymmetric stiffness relative to the longitudinal plane LP.

The length of the connecting rod 118 can be varied. In one embodiment, the connecting rod 118 does not include any holes in the connecting rod 118 for lubrication.

Piston end 124 includes a bore 126 that in some embodiments is sized to receive a bearing (not illustrated). If the bearing is assembled with the bore 126, then the bearing has an internal diameter that is sized to receive a piston pin 116. In other embodiments, the bore 126 is sized to receive the piston pin 116 without the bearing. The center axis P at the piston end 124 is further defined at the center of the bore 126 and aligns with a piston axis of the piston 111 when the connecting rod 118 is assembled with the piston pin 116.

The crank end 125 includes a yoke 130 and a cap 122. Yoke 130 includes a semi-circular opening 132 and a shoulder 133. Cap 122 includes a semi-circular opening 134 that, together with semi-circular opening 132, define a crank end bore 136 for receiving the crankshaft pivot pin 137 of the engine 102. In some embodiments, a bearing is disposed within semi-circular openings 132, 134 between the crankshaft and yoke 130 and cap 122. It is contemplated that bearing may be a two-piece bearing for assembly purposes. Bearing may be a friction-type bearing, fabricated from a malleable material, for example aluminum. It should be noted, however, that any other suitable material may alternatively be utilized for bearing. In addition, cap 122 may include a pair of shoulders 140 configured to receive a plurality of bolts 123, which allow cap 122 to be removably connected to crank end 125 of connecting rod 118. The center axis C at the crank end 125 is aligned with a center of the crankshaft pivot pin 137 of the engine 102. In this embodiment, the crankshaft pivot pin 137 is laterally offset a distance from the piston axis of the piston 111 when the connecting rod 118 is assembled with the crankshaft pivot pin 137.

As shown in FIG. 2, cap 122 may be connected to yoke 130 at parting lines 208. In one embodiment, cap 122 and yoke 130 may have fractured, uneven surfaces that engage each other at parting lines 208, though other suitable forms of complimentary surfaces may alternatively be utilized. For example, in alternative embodiments, serrated or substantially flat machined surfaces may join cap 122 and yoke 130 at parting lines 208. The surfaces of cap 122 and yoke 130 at parting lines 208 may define a separation plane 212.

The shank 120 extends between the piston end 124 and the opposing crank end 125. The shank 120 includes an offset side surface 140 and an anti-offset side surface 142 with respect to the longitudinal plane LP. The shank 120 includes a first column portion 144 that extends between the piston end 124 and the opposing crank end 125 and includes the offset side surface 140. The shank 120 includes a second column portion 146 that extends between the piston end 124 and the opposing crank end 125 and includes the anti-offset side surface 142. The offset side surface 140 is parallel or substantially parallel to the anti-offset side surface 142 wherein both of the offset and anti-offset side surfaces 140 and 142, respectively, are parallel to the longitudinal plane LP. The offset and anti-offset side surfaces 140 and 142, respectively, are not inclined about an axis of the cylinder bore. The first column portion 144 is positioned closer to the longitudinal plane LP than the second column portion 146 is positioned to the longitudinal plane LP such that the shank 120 is offset relative to the longitudinal plane LP. As such, the anti-offset side surface 142 is located further away from or positioned a greater distance from the longitudinal plane LP than the offset side surface 140. Or stated differently, the offset side surface 140 is located closer or positioned a smaller distance to the longitudinal plane LP than the anti-offset side surface 142.

The shank 120 includes a front cavity 148 and a rear cavity 150 that extend between the first and second column portions 144 and 146 to form a web 152 positioned between the first column portion 144 and the second column portion 146. The front and rear cavities 148 and 150 are directionally parallel to the longitudinal plane LP of the connecting rod 118.

Turning to FIG. 3, the shank 120 having an I-beam cross-sectional shape that is asymmetrical relative to the longitudinal plane LP is illustrated. The first column portion 144 has a cross-sectional first length L1 and a first width W1 that form a first cross-sectional area 154 of the first column portion 144. In the illustrated embodiment, the cross-sectional first length L1 extends away from the longitudinal plane LP. In other embodiments the longitudinal plane LP extends through the cross-sectional first length L1 or the longitudinal plane LP extends through the web 152. The first column portion 144 has a first stiffness or flexural rigidity associated with a cross-sectional area of the first column portion 144.

The second column portion 146 has a cross-sectional second length L2 and a second width W2 that form a second cross-sectional area 156 of the second column portion 146. The second column portion 146 has a second stiffness or flexural rigidity associated with a cross-sectional area 156 of the second column portion 146. In the illustrated embodiment, the first width W1 of the first column portion 144 is the same as or substantially the same as the second width W2 of the second column portion 146 such that the shank 120 has an even or constant width of the first and second column portions 144 and 146, respectively. The second length L2 of the second column portion 146 is shorter or less than the first length L1 of the first column portion 144. As such, the first column portion 144 has a higher stiffness and larger cross-sectional area as compared to the second column portion 146 which has a smaller stiffness and smaller cross-sectional area.

The web 152 has a cross-sectional length L3 and a web width W3 that is further defined by the front and rear cavities 148 and 150. The web 152 is positioned closer to the anti-offset side surface 142 such that the front and rear cavities 148 and 150, respectively, are offset to one side, that is the anti-offset side, of the longitudinal plane LP. The web 152 has a third stiffness or flexural rigidity associated with a cross-sectional area 158 of the web 152. The combined lengths L2 and L3, respectively, of the second column portion 146 and the web 152 are longer than the length L1 of the first column portion 144. In other words, the length L1 of the first column portion 144 is less than the combined lengths L2 and L3, respectively, of the second column portion 146 and the web 152. The unique position of the web 152 and the second column portion 146 on one side, that is the anti-offset side, of the longitudinal plane LP whereas the first column portion 144 is positioned on the offset side of the longitudinal plane LP forms an asymmetric or non-symmetric shank relative to the longitudinal plane LP.

As illustrated in FIG. 3, the combined cross-sectional shape of the first column portion 144, the web 152, and the second column portion 146 collectively form an I-beam cross-sectional shape for the connecting rod 118. The I-section of the connecting rod 118 is lightweight compared to a solid cross-sectional shape of other connecting rods. Additionally, the I-section of the connecting rod 118 lowers the inertia forces compared to other connecting rods. The cross-sectional first length L1 of the first column portion 144 is larger than the cross-sectional second length L2 of the second column portion 146 to form an asymmetric cross-sectional shape for the shank 120. Additionally, since the first length L1 of the first column portion 144 is larger than the second length L2 of the second column portion 146, the cross-sectional area of the first column portion 144 is larger than the cross-sectional area of the second column portion 146.

Since the first column portion 144 is positioned on the offset side of the longitudinal plane LP, the stiffness of the first column portion 144 is different from a combined stiffness of the second column portion 146 and the web 152. The second column portion 146 and the web 152 are positioned on the anti-offset side of the longitudinal plane LP. Beneficially, the higher stiffness of the first column portion 144 prevents bending of the shank 120 and achieves an overall stress reduction. The cross-sectional area of the first column portion 144 in some embodiments may be greater than a combined cross-sectional area of the second column portion 146 and the web 152. In other embodiments, the cross-sectional area of the first column portion 144 may be less than a combined cross-sectional area of the second column portion 146 and the web 152.

A degree of bias of the first column portion 144 on the offset side of the longitudinal plane LP is constant across the length of the connecting rod 118. A degree of bias of the second column portion 146 and the web 152 on the anti-offset side of the longitudinal plane LP is constant across the length of the connecting rod 118. The first column portion 144 having a larger length L1 or thickness on the side of the offset of the longitudinal plane LP can withstand higher compressive loads including bending loads while also providing adequate tensile strength.

As is evident from the figures and text presented above, a variety of aspects of the present disclosure are contemplated.

Various aspects of the present application are contemplated. According to one aspect, a connecting rod for an internal combustion engine, comprising: a connecting rod body having a piston end, a crank end, and a shank that extends between the piston end and the crank end, the piston end includes a piston axis and the crank end includes a crank axis, wherein the connecting rod body has a longitudinal plane that extends between the piston axis and the crank axis; and wherein the shank has a cross-sectional shape that is asymmetrical relative to the longitudinal plane.

In one embodiment, wherein the shank includes a first column portion, a second column portion, and a web portion that extends between the first and the second column portions; wherein the first column portion includes an offset side surface that extends between the piston end and the crank end; wherein the second column portion includes an anti-offset side surface that extends between the piston end and the crank end; and wherein the web portion is positioned closer to the anti-offset side surface than to the offset side surface.

In one embodiment, wherein the shank includes a front cavity and a rear cavity that extend between the first and second column portions to define a width of the web portion.

In one embodiment, wherein the anti-offset side surface and the offset side surface are each substantially parallel to the longitudinal plane.

In one embodiment, wherein the first column portion has a cross-sectional area with a first stiffness, the second column portion and the web have a combined cross-sectional area with a second stiffness, wherein the first stiffness is greater than the second stiffness.

In one embodiment, wherein the anti-offset side surface is positioned a greater distance from the longitudinal plane than a distance that the offset side surface is positioned from the longitudinal plane.

In one embodiment, wherein the first column portion has a cross-sectional area, the second column portion and the web have a combined cross-sectional area, wherein the cross-sectional area of the first column portion is less than the combined cross-sectional area of the second column portion and the web.

In one embodiment, wherein the first column portion has a cross-sectional first length and a first width that together define a first cross-sectional area; and wherein the second column portion has a cross-sectional second length and a second width that together define a second cross-sectional area, wherein the second length of the second column portion is less than the first length of the first column portion.

In one embodiment, wherein the shank has an asymmetric stiffness relative to the longitudinal plane.

In one embodiment, wherein the crank end of the connecting rod body is assembled with a crankshaft.

According to another aspect, a connecting rod for an internal combustion engine, comprising: a connecting rod body having a piston end and a crank end, the piston end includes a piston axis about which the piston end pivots, the crank end includes a crank axis about which the crank end rotates, the connecting rod body has a longitudinal plane that extends between the piston axis and the crank axis; the connecting rod body includes a shank that extends between the piston and the crank ends, wherein the shank has an asymmetric stiffness relative to the longitudinal plane.

In one embodiment, wherein the shank has a cross-sectional shape that is asymmetrical relative to the longitudinal plane.

In one embodiment, wherein the shank includes a first column portion, a second column portion, and a web portion that extends between the first and the second column portions, wherein the shank includes a front cavity and a rear cavity that extend between the first and second column portions to define a width of the web portion.

In one embodiment, wherein the first column portion includes an offset side surface that extends between the piston end and the crank end; wherein the second column portion includes an anti-offset side surface that extends between the piston end and the crank end; and wherein the web portion is positioned closer to the anti-offset side surface than to the offset side surface.

In one embodiment, wherein the anti-offset side surface and the offset side surface are each substantially parallel to the longitudinal plane.

In one embodiment, wherein the first column portion has a cross-sectional area with a first stiffness, the second column portion and the web have a combined cross-sectional area with a second stiffness, wherein the first stiffness is greater than the second stiffness.

In one embodiment, wherein the anti-offset side surface is positioned a greater distance from the longitudinal plane than a distance that the offset side surface is positioned from the longitudinal plane.

In one embodiment, wherein the first column portion has a cross-sectional area, the second column portion and the web have a combined cross-sectional area, wherein the cross-sectional area of the first column portion is less than the combined cross-sectional area of the second column portion and the web.

In one embodiment, wherein the first column portion has a cross-sectional first length and a first width that together define a first cross-sectional area; and wherein the second column portion has a cross-sectional second length and a second width that together define a second cross-sectional area, wherein the second length of the second column portion is less than the first length of the first column portion.

In one embodiment, wherein the first column portion has a cross-sectional area, the second column portion and the web have a combined cross-sectional area, wherein the cross-sectional area of the first column portion is greater than the combined cross-sectional area of the second column portion and the web . . . .

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A connecting rod for an internal combustion engine, comprising:
a connecting rod body having a piston end, a crank end, and a shank that extends between the piston end and the crank end, the piston end includes a piston axis and the crank end includes a crank axis, wherein the connecting rod body has a longitudinal plane that extends between the piston axis and the crank axis; and
wherein the shank has a cross-sectional shape that is asymmetrical relative to the longitudinal plane.

2. The connecting rod of claim 1, wherein the shank includes a first column portion, a second column portion, and a web portion that extends between the first and the second column portions;
wherein the first column portion includes an offset side surface that extends between the piston end and the crank end;
wherein the second column portion includes an anti-offset side surface that extends between the piston end and the crank end; and
wherein the web portion is positioned closer to the anti-offset side surface than to the offset side surface.

3. The connecting rod of claim 2, wherein the shank includes a front cavity and a rear cavity that extend between the first and second column portions to define a width of the web portion.

4. The connecting rod of claim 2, wherein the anti-offset side surface and the offset side surface are each substantially parallel to the longitudinal plane.

5. The connecting rod of claim 2, wherein the first column portion has a cross-sectional area with a first stiffness, the second column portion and the web have a combined cross-sectional area with a second stiffness, wherein the first stiffness is greater than the second stiffness.

6. The connecting rod of claim 2, wherein the anti-offset side surface is positioned a greater distance from the longitudinal plane than a distance that the offset side surface is positioned from the longitudinal plane.

7. The connecting rod of claim 2, wherein the first column portion has a cross-sectional area, the second column portion and the web have a combined cross-sectional area, wherein the cross-sectional area of the first column portion is less than the combined cross-sectional area of the second column portion and the web.

8. The connecting rod of claim 2, wherein the first column portion has a cross-sectional first length and a first width that together define a first cross-sectional area; and
wherein the second column portion has a cross-sectional second length and a second width that together define a second cross-sectional area, wherein the second length of the second column portion is less than the first length of the first column portion.

9. The connecting rod of claim 1, wherein the shank has an asymmetric stiffness relative to the longitudinal plane.

10. The connecting rod of claim 1, wherein the crank end of the connecting rod body is assembled with a crankshaft.

11. A connecting rod for an internal combustion engine, comprising:
a connecting rod body having a piston end and a crank end, the piston end includes a piston axis about which the piston end pivots, the crank end includes a crank axis about which the crank end rotates, the connecting rod body has a longitudinal plane that extends between the piston axis and the crank axis;
the connecting rod body includes a shank that extends between the piston and the crank ends, wherein the shank has an asymmetric stiffness relative to the longitudinal plane.

12. The connecting rod of claim 11, wherein the shank has a cross-sectional shape that is asymmetrical relative to the longitudinal plane.

13. The connecting rod of claim 11, wherein the shank includes a first column portion, a second column portion, and a web portion that extends between the first and the second column portions, wherein the shank includes a front cavity and a rear cavity that extend between the first and second column portions to define a width of the web portion.

14. The connecting rod of claim 13, wherein the first column portion includes an offset side surface that extends between the piston end and the crank end;
wherein the second column portion includes an anti-offset side surface that extends between the piston end and the crank end; and
wherein the web portion is positioned closer to the anti-offset side surface than to the offset side surface.

15. The connecting rod of claim 14, wherein the anti-offset side surface and the offset side surface are each substantially parallel to the longitudinal plane.

16. The connecting rod of claim 13, wherein the first column portion has a cross-sectional area with a first stiffness, the second column portion and the web have a combined cross-sectional area with a second stiffness, wherein the first stiffness is greater than the second stiffness.

17. The connecting rod of claim 14, wherein the anti-offset side surface is positioned a greater distance from the longitudinal plane than a distance that the offset side surface is positioned from the longitudinal plane.

18. The connecting rod of claim 13, wherein the first column portion has a cross-sectional area, the second column portion and the web have a combined cross-sectional area, wherein the cross-sectional area of the first column portion is less than the combined cross-sectional area of the second column portion and the web.

19. The connecting rod of claim 13, wherein the first column portion has a cross-sectional first length and a first width that together define a first cross-sectional area; and
wherein the second column portion has a cross-sectional second length and a second width that together define a second cross-sectional area, wherein the second length of the second column portion is less than the first length of the first column portion.

20. The connecting rod of claim 13, wherein the first column portion has a cross-sectional area, the second column portion and the web have a combined cross-sectional area, wherein the cross-sectional area of the first column portion is greater than the combined cross-sectional area of the second column portion and the web.
